(19) United States
(12) Patent Application Publication
(10) Pub. No.: US 2013/0134095 A1
(43) Pub. Date: May 30, 2013

(54) TWO-DIMENSIONAL LIQUID CHROMATOGRAPHY WITH CONTROL OF INJECTION IN RELATION TO A STATE OF THE SECOND DIMENSION CHROMATOGRAPH

(71) Applicants: Herbert Anderer, Waldbronn (GB); Klaus Witt, Keltern (GB)

(72) Inventors: Herbert Anderer, Waldbronn (GB); Klaus Witt, Keltern (GB)

(73) Assignee: AGILENT TECHNOLOGIES, INC., Loveland, CO (US)

(21) Appl. No.: 13/301,566

(22) Filed: Nov. 21, 2011

(30) Foreign Application Priority Data
Dec. 21, 2010 (GB) 1021547.3

(51) Int. Cl. B01D 15/08

(52) U.S. Cl. CPC B01D 15/08
USPC 210/656; 210/198.2

(57) ABSTRACT

A two-dimensional liquid chromatography in a system (200) comprises a first liquid chromatograph (210) coupled with a second liquid chromatograph (220). An injection event of injecting an output of the first liquid chromatograph (210) into the second liquid chromatograph (220) is controlled (290) in relation to a state (600, 610; 620, 630) of the second liquid chromatograph (220). FIG. 6A for publication

### BACKGROUND ART

The present invention relates to two-dimensional liquid chromatography.

In high performance liquid chromatography (HPLC), a liquid has to be provided usually at a very controlled flow rate (e. g. in the range of microliters to milliliters per minute) and at high pressure (typically 20-100 MPa, 200-1000 bar, and beyond up to currently 200 MPa, 2000 bar) at which compressibility of the liquid becomes noticeable. For liquid separation in an HPLC system, a mobile phase comprising a sample fluid with compounds to be separated is driven through a stationary phase (such as a chromatographic column), thus separating different compounds of the sample fluid which may then be identified.

The mobile phase, for example a solvent, is pumped under high pressure typically through a column of packing medium (also referred to as packing material), and the sample (e.g. a chemical or biological mixture) to be analyzed is injected into the column. As the sample passes through the column with the liquid, the different compounds, each one having a different affinity for the packing medium, move through the column at different speeds. Those compounds having greater affinity for the packing medium move more slowly through the column than those having less affinity, and this speed differential results in the compounds being separated from one another as they pass through the column.

The mobile phase with the separated compounds exits the column and passes through a detector, which identifies the molecules, for example by 25 spectrophotometric absorbance measurements. A two-dimensional plot of the detector measurements against elution time or volume, known as a chromatogram, may be made, and from the chromatogram the compounds may be identified. For each compound, the chromatogram displays a separate curve or “peak”. Effective separation of the compounds by the column is advantageous because it provides for measurements yielding well defined peaks having sharp maxima inflection points and narrow base widths, allowing excellent resolution and reliable identification of the mixture constituents. Broad peaks, caused by poor column performance, so called “Internal Band Broadening” or poor system performance, so called “External Band Broadening” are undesirable as they may allow minor components of the mixture to be masked by major components and go unidentified.

An HPLC column typically comprises a stainless steel tube having a bore containing a packing medium comprising, for example, silane derivatized silica spheres having a diameter between 0.5 to 50 μm, or 1-10 μm or even 1-7 μm. The medium is 10 packed under pressure in highly uniform layers which ensure a uniform flow of the transport liquid and the sample through the column to promote effective separation of the sample constituents. The packing medium is contained within the bore by porous plugs, known as “frits”, positioned at opposite ends of the tube. The porous frits allow the transport liquid and the chemical sample to pass while retaining the packing medium within the bore. After being filled, the column may be coupled or connected to other elements (like a control unit, a pump, containers including samples to be analyzed) by e.g. using fitting elements. Such fitting elements may contain porous parts such as screens or fit elements.

During operation, a flow of the mobile phase traverses the column filled with the stationary phase, and due to the physical interaction between the mobile and the stationary phase a separation of different compounds or components may be achieved. In case the mobile phase contains the sample fluid, the separation characteristics is usually adapted in order to separate compounds of such sample fluid. The term compound, as used herein, shall cover compounds which might comprise one or more different components. The stationary phase is subject to a mechanical force generated in particular by a hydraulic pump that pumps the mobile phase usually from an upstream connection of the column to a downstream connection of the column. As a result of flow, depending on the physical properties of the stationary phase and the mobile phase, a relatively high pressure occurs across the column.

JP 5157743 A1 discloses a liquid chromatograph wherein a control part determines, by detection or computation, the period of the operation of a moving-phase supply part and controls injection of a sample on the basis of the determination to improve reproducibility of analysis. The control part gives each part an instruction for operation at a specified timing of the period and makes injection of a sample and analysis under the same conditions be executed repeatedly automatically. The sample injection is repeated automatically and executed at the specified timing of the period of a change in the amount of discharge of the pump, so that the conditions at the time of the injection are made invariable and execution of analysis with increased reproducibility.

EP 0993330 B1 discloses an HPLC system having an active phasing to actively restore the substantially exact mechanical positions of driven components in a delivery system in order to precisely reproduce the mechanical signature and hydraulic characteristics of the system from run to run without perturbing output flow. The delivery system is configured to drive pump pistons to a known position and to delivery fluid(s) at a known pressure.

DE 102008000111 A1 discloses an HPLC system wherein a controller controls a piston of a piston pump by varying stroke length, such that the piston achieves a target position associated to a preset target time period for injecting a sample into a measuring device.

In some cases, one column may not be sufficient to provide a desired separation. In two-dimensional liquid chromatography, output (eluent) from a first column is input to a second column. Typically, the second column provides a different separation mechanism, so that bands which are poorly resolved from the first column may be completely separated in the second column. For instance, a C18 column may be followed by a phenyl column. Alternately, the two columns might run at different temperatures. Two-dimensional techniques may offer an increase in peak capacity without requiring extremely efficient separations in either column. Multi-dimensional liquid chromatography is based on two-dimensional liquid chromatography and further couples an output from the second column as input to a third column, an output from the third column as input to a forth column, etc.

The publication “Automated Instrumentation for Comprehensive Two-Dimensional High-Performance Liquid Chromatography of Proteins”, M. Bushey et al., Anal. Chem. 1990, vol. 62, pp. 161-167, and U.S. Pat. No. 5,196,039 A both describe further details such two-dimensional or multi-dimensional liquid chromatography.

### SUMMARY OF THE INVENTION

It is an object of the invention to provide an improved two-dimensional liquid 5 chromatography. The object is solved by the independent claim(s). Further embodiments are shown by the dependent claim(s).

According to the present invention, a two-dimensional liquid chromatography is provided in a system comprising a first liquid chromatograph coupled with a second liquid chromatograph. An injection event occurs by injecting an output of the first liquid 10 chromatograph into the second liquid chromatograph. The injection event is controlled, e.g. by controlling operation of an injection valve, in relation to a state of the second liquid chromatograph. This allows increasing reproducibility of the second dimension separation, as provided by the second liquid chromatograph, by relating the injection to the state of the second liquid chromatograph, which state may represent, for example, a specific mechanical configuration of or within the second liquid chromatograph, such as a direction of movement or a position (e.g. with respect to a turning point of the first piston) of a piston.

In one embodiment, the second liquid chromatograph comprises a reciprocating pump. The reciprocating pump is a dual pump having a primary piston 20 and a secondary piston. The primary piston is configured to intake fluid and to supply the fluid to the secondary piston, and the secondary piston is configured to output the fluid under pressure. The state can at least one of: a moving direction of the secondary piston, a position of the secondary piston, and a cycle wherein the primary piston does not supply fluid to the secondary piston. Dual pumps are often used in HPLC as they 25 allow providing continuous flow. In embodiments where the secondary piston predominantly provides the output of the fluid under pressure, the state of the secondary piston has the main influence on the repeatability and accuracy of the two-dimensional separation. A so-called de-fill cycle, wherein the primary piston supplies fluid to the secondary piston, is preferably avoided to coincide with the injection event.

In one embodiment, the second liquid chromatograph is operated in a “gradient mode”. In the gradient mode, a composition of a solvent mixture is varied over time, which is very common specifically in reversed phase chromatography, where the analysis starts, e.g., with higher aqueous content while gradually ramping to more organic content during the course of analysis. A programmed solvent mixture 5 provides a gradient mobile phase for transporting the injected output from the first liquid chromatograph through the second liquid chromatograph for providing the separation in the second dimension. This may help in two aspects. On one hand, the injected plug (i.e. the output of the first liquid chromatograph injected into the second liquid chromatograph) is loaded onto the second dimension column under conditions at 10 which it first concentrates on the packing material, while on the other hand the total volume needed for elution is reduced because later peaks are eluted with increased elution strength. Both aspects can be optimized independently e.g. by selecting adequate gradient conditions (as described e.g. in “Generation and Limitations of Peak Capacity in Online Two-Dimensional Liquid Chromatography”, by Krisztian Horvath, Jacob N. Fairchild, and Georges Guiochon, Anal.Chem., 2009, 81, 3879-3888).

In one embodiment, the second liquid chromatograph comprises a first reciprocating pump having a first piston reciprocating in the first reciprocating pump, and a second reciprocating pump having a second piston reciprocating in the second reciprocating pump. The injection event is controlled in relation to the state of the first piston, a state of the second piston, or a combination thereof.

The first reciprocating pump can be operated to pump a first solvent, while the second reciprocating pump can be operated to pump a second solvent. The first and second solvent can be mixed to a solvent mixture, which is then provided as a mobile phase to a separation unit of the second liquid chromatograph. The output of 25 the first liquid chromatograph is injected into the solvent mixture, which represents a respective injection event. The composition of the solvent mixture can be provided to be essentially constant (usually referred to as “isocratic mode”) or to vary over time as in the aforementioned gradient mode. Such variation over time can be stepwise, continuous (dependent on resolution of the system), or have any other course over time.

In one embodiment, the second liquid chromatograph's pumping system may comprise a second reciprocating piston reciprocating in the second pump chamber, being coupled downstream from the first reciprocating pump (e.g. after an outlet valve). The injection event is then controlled preferably in relation to the state of the second piston, but may be as well controlled in relation to a combination of states or positions of the first and second piston.

The state of a respective piston (e.g. the first piston or the second piston), to which the injection event is controlled in relation to, can be a given state, which might be defined by a user of the system and/or by a control unit in the system configured for controlling operation at least of the second liquid chromatograph. The state of a 10 respective piston can be a (e.g. mechanical) position of the respective piston reciprocating in the respective reciprocating pump. The position or state of a respective piston may be defined by a distance of the respective piston e.g. from a reversal point (e.g. top dead center and/or outer dead center) of the respective piston in its reciprocating pump. Alternatively or in addition, the state of the respective piston may be defined by a direction of movement of the respective piston in its reciprocating pump, e.g. being in a forward or backward movement.

The state of the piston can also be the same state in which the piston was when a previous injection occurred, for example, the same position and/or the same moving direction of the piston when the previous injection occurred. The previous injection is preferably a first injection in a sequence of injections.

In one embodiment, the state of a respective piston is defined as either being in a reversal point of the piston (or at least in a given range around the reversal point) or not being in the reversal point of the piston (or at least not in the given range around the reversal point). In such embodiment, the injection event is controlled not 25 with respect to an absolute mechanical position of a respective reciprocating pump but with respect to a relative position of either being in a reversal state (i.e. in the reversal point or in the given range around) or not. Such embodiment may avoid that one or more of the pistons is/are in such reversal state which may allow avoiding critical pumping configurations (e.g. when at least one pump is in the reversal state) and thus increase repeatability of the separation.

In one embodiment, operation of the second liquid chromatograph is controlled in order to set the state in relation to a desired value for the injection event. Preferably, operation of a reciprocating pump of the second liquid chromatograph is controlled in order to set the state of the second liquid chromatograph in relation to the desired value for the injection event. This allows adjusting the separation of the second 5 dimension to a desired injection, for example to a desired point in time of the injection. Accordingly, this may allow adjusting the configuration of the second liquid chromatograph to a specific and/or current configuration or operation mode of the first liquid chromatograph, for example to a desired injection rate. An injection rate can represent a multitude of injections each after a target interval following the succeeding injection, for example following every twenty seconds as promoted in “The impact of sampling time on peak capacity and analysis speed in on-line comprehensive two-dimensional liquid chromatography”, by Lawrence W. Pottsa, Dwight R. Stoll, Xiaoping Li, and Peter W. Carr, Journal of Chromatography A, 1217 (2010) 5700-5709.

Controlling operation of the second liquid chromatograph in order to set the state may comprise setting the stroke of a respective piston. This may be done as taught in the aforementioned EP 309596 A1 or DE 102008000111 A1.

In one embodiment, operation of the second liquid chromatograph is controlled in order to set the state in relation to a desired value of an injection volume. The injection volume represents a volume of the output of the first liquid 20 chromatograph injected (during a respective injection event) into the second liquid chromatograph. Preferably, the first reciprocating pump of the second liquid chromatograph can be operated in order to set the state of the first piston in relation to the desired value of the injection volume. Such volume-based controlling can be provided as disclosed in the International Application WO 2009/062538 A1 by the same applicant. The teaching thereof with respect to controlling operation of chromatography systems based on retention volumes rather than retention times shall be incorporated herein by reference.

In one embodiment, a plurality of injection events is controlled in relation to a pattern of the state of the first reciprocating pump. Each injection event represents an 30 injection of a respective output of the first liquid chromatograph as a respective input into the second liquid chromatograph. The pattern may be a repetitive pattern. The pattern may be a pattern of the state of a piston reciprocating in a reciprocating pump.

In one embodiment, the pattern comprises an incident repeating in the pattern. Such incident may be a specific mechanical configuration, for example a given position of one or more pistons. Each injection event is then controlled to occur in relation to a respective one of the repeating incidence, for example to occur with the occurrence of a respective incident. The incidence may thus virtually provide a grating of incidences, and the injection events are controlled to match with the grating.

In one embodiment, operation of the second liquid chromatograph is controlled in order to set a repetition rate of the pattern to a desired value. Preferably, 10 operation of a reciprocating pump of the second liquid chromatograph is controlled for that purpose. The operation of the second liquid chromatograph may be controlled in order to vary a repetition rate of the pattern to match with a desired value of a respective injection invent. Preferably, operation of the reciprocating pump is controlled in order to vary the repetition rate. Such embodiments may allow adjusting the pattern of the second dimension, for example to a desired volume of an injection or a desired interval between successive injections.

In one embodiment, operation of the first liquid chromatograph is controlled in order to relate a volume, provided as input into the second liquid chromatograph, to a repetition rate of the pattern. This allows avoiding that the output from the first liquid chromatograph overfills the second liquid chromatograph, or that the first liquid chromatograph provides as output a larger volume of liquid than the second liquid chromatograph can process, so that a portion of the sample provided to the first liquid chromatograph may remain unprocessed by the second liquid chromatograph.

In one embodiment, the volume provided as input into the second liquid chromatograph is controlled to be less or equal than a volume that a sample loop can handle for injecting into the second liquid chromatograph. Even in the case of varying flow rates this allows ensuring that the entire output from the first liquid chromatograph can be input into and processed by the second liquid chromatograph and that no portion of a sample may get lost or remain unprocessed by the second dimension.

In one embodiment, an actually injected volume for or during a respective injection event is recorded. The actually injected volume represents the volume of the output of the first liquid chromatograph as input into the second liquid chromatograph by or during a respective injection event. A respective measuring result, as obtained by the second liquid chromatograph when processing the respective injected volume, is 5 evaluated in relation to the recorded actually injected volume for the respective injection event. This can ensure that the actual volume of the injected liquid is considered for the evaluation of the measuring result in contrast to a mere assumption that the injected volume is at least substantially constant or equal in each injection event. The evaluation of the measuring result in relation to the recorded actually injected volume can comprise a scaling of the measuring results, e.g. a scaling of a derived chromatogram, to the actually injected volume, thus leading to a higher accuracy of the measuring results, for example a higher accuracy of derived concentration values of separated compounds.

In one embodiment, the injection event is controlled by controlling the injection to be at a timing, when the output of the first liquid chromatograph is injected as input into the second liquid chromatograph.

In one embodiment, one or more of the reciprocating pumps each further comprises a further reciprocating pump coupled in series or parallel thereto in order to provide substantially continues output flow, for example as disclosed in EP 309596 A1, which will be discussed later in greater detail.

The two-dimensional liquid chromatography can be provided by first separating compounds of a sample fluid by means of the first liquid chromatograph, thus representing a first dimension of separation. During an injection event, a compound as separated by the first liquid chromatograph is injected into the second liquid chromatograph. The second liquid chromatograph (further) separates compounds of the injected compound, thus providing the second dimension of separation. It is clear that further dimensions can be added to such system to provide a multi-dimension chromatography as known in the art.

The first and second liquid chromatographs are preferably configured to provide different separation mechanisms, for example size exclusion chromatography coupled with reversed phase separation (SEC/RP-LC), or IEC/RP-LC, as disclosed e.g. in “An Automated On-Line Multidimensional HPLC System for Protein and Peptide Mapping with Integrated Sample Preparation”, by Knut Wagner, Tasso Miliotis, György Marko-Varga, Rainer Bischoff, and Klaus K. Unger, Anal. Chem. 2002, 74, 809-820.

The invention can be embodied by respective methods, software programs 5 or products for controlling or executing such methods, and/or an apparatus of a two-dimensional fluid separation system.

In one embodiment, a two-dimensional fluid separation system comprises a first liquid chromatograph and a second liquid chromatograph, each being configured for separating compounds of a sample fluid. The second liquid chromatograph may comprise a piston reciprocating in a reciprocating pump. A controller of the system is configured for controlling an injection event in relation to a state of the second liquid chromatograph, e.g. a state of the first piston. The injection event represents an injection of an output of the first liquid chromatograph into the second liquid chromatograph.

Embodiments of the present invention might be embodied based on most conventionally available HPLC systems, such as the Agilent 1290 Series Infinity system, Agilent 1200 Series Rapid Resolution LC system, or the Agilent 1100 HPLC series (all provided by the applicant Agilent Technologies—see www.agilent.com which shall be incorporated herein by reference).

One embodiment of an HPLC system comprises a pumping apparatus having a piston for reciprocation in a pump working chamber to compress liquid in the pump working chamber to a high pressure at which compressibility of the liquid becomes noticeable.

One embodiment of an HPLC system comprises two pumping apparatuses coupled either in a serial or parallel manner. In the serial manner, as disclosed in the aforementioned EP 309596 A1, an outlet of the first pumping apparatus is coupled to an inlet of the second pumping apparatus, and an outlet of the second pumping apparatus provides an outlet of the pump. In the parallel manner, an inlet of the first pumping apparatus is coupled to an inlet of the second pumping apparatus, and an outlet of the first pumping apparatus is coupled to an outlet of the second pumping apparatus, thus providing an outlet of the pump. In either case, a liquid outlet of the first pumping apparatus is phase shifted, preferably essentially 180 degrees, with respect to a liquid outlet of the second pumping apparatus, so that only one pumping apparatus is supplying into the system while the other is intaking liquid (e.g. from the 5 supply), thus allowing to provide a continuous flow at the output. However, it is clear that also both pumping apparatuses might be operated in parallel (i.e. concurrently), at least during certain transitional phases e.g. to provide a smooth(er) transition of the pumping cycles between the pumping apparatuses. The phase shifting might be varied in order to compensate pulsation in the flow of liquid as resulting from the compressibility of the liquid. It is also known to use three piston pumps having about 120 degrees phase shift.

The separating device preferably comprises a chromatographic column providing the stationary phase. The column might be a glass or steel tube (e.g. with a diameter from 50 μm to 5 mm and a length of 1 cm to 1 m) or a microfluidic column (as 15 disclosed e.g. in EP 1577012 A1 or the Agilent 1200 Series HPLC-Chip/MS System provided by the applicant Agilent Technologies, see e.g. http://www.chem.agilent.com/Scripts/PDS.asp?1Page=38308). For example, a slurry can be prepared with a powder of the stationary phase and then poured and pressed into the column. The individual components are retained by the stationary phase 20 differently and separate from each other while they are propagating at different speeds through the column with the eluent. At the end of the column they elute one at a time. During the chromatography process the eluent might be also collected in a series of fractions. The stationary phase or adsorbent in column chromatography usually is a solid material. The most common stationary phase for column chromatography is silica gel, followed by alumina. Cellulose powder has often been used in the past. Also possible are ion exchange chromatography, reversed-phase chromatography (RP), affinity chromatography or expanded bed adsorption (EBA). The stationary phases are usually finely ground powders or gels and/or are microporous for an increased surface, though in EBA a fluidized bed is used.

The mobile phase (or eluent) can be either a pure solvent or a mixture of different solvents. It can be chosen e.g. to minimize the retention of the compounds of interest and/or the amount of mobile phase to run the chromatography. The mobile phase can also been chosen so that the different compounds can be separated effectively. The mobile phase might comprise an organic solvent like e.g. methanol or acetonitrile, often diluted with water. For gradient operation water and organic is delivered in separate bottles, from which the gradient pump delivers a programmed blend to the system. Other commonly used solvents may be isopropanol, THF, hexane, ethanol and/or any combination thereof or any combination of these with aforementioned solvents.

The sample fluid might comprise any type of process liquid, natural sample like juice, body fluids like plasma or it may be the result of a reaction like from a fermentation broth.

The fluid is preferably a liquid but may also be or comprise a gas and/or a supercritical fluid (as e.g. used in supercritical fluid chromatography—SFC—as disclosed e.g. in U.S. Pat. No. 4,982,597 A).

The pressure in the mobile phase might range from 2-200 MPa (20 to 2000 bar), in particular 10-150 MPa (100 to 1500 bar), and more particular 50-120 MPa (500 to 1200 bar).

The HPLC system might further comprise a sampling unit for introducing the sample fluid into the mobile phase stream, a detector for detecting separated compounds of the sample fluid, a fractionating unit for outputting separated compounds of the sample fluid, or any combination thereof. Further details of HPLC system are disclosed with respect to the aforementioned Agilent HPLC series, provided by the applicant Agilent Technologies, under www.agilent.com which shall be in cooperated herein by reference.

Embodiments of the invention can be partly or entirely embodied or supported by one or more suitable software programs, which can be stored on or otherwise provided by any kind of data carrier, and which might be executed in or by any suitable data processing unit. Software programs or routines can be preferably applied in or by the control unit.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawing(s). Features that are substantially or functionally equal or similar will be referred to by the same reference sign(s). The illustration in the drawing is schematically.

FIG. 1 shows a liquid separation system 10, in accordance with embodiments of the present invention, e.g. used in high performance liquid chromatography (HPLC).

FIG. 2 schematically illustrates a two-dimensional fluid separation system 200.

FIGS. 3A and 3B show an embodiment of the injector 270 depicted in the context of the embodiment of FIG. 2.

FIG. 4 shows an embodiment of the pumping unit 265 as a dual piston serial 15 type pump.

FIG. 5 schematically illustrates an embodiment of the pump 260, wherein both pumping units 265 and 267 are each comprised of a dual serial type pumping unit as schematically depicted in FIG. 4.

FIGS. 6A and 6B illustrate schematically examples of piston movements for 20 an isocratic mode (FIG. 6A) and a gradient mode (FIG. 6B).

### DETAILED DESCRIPTION

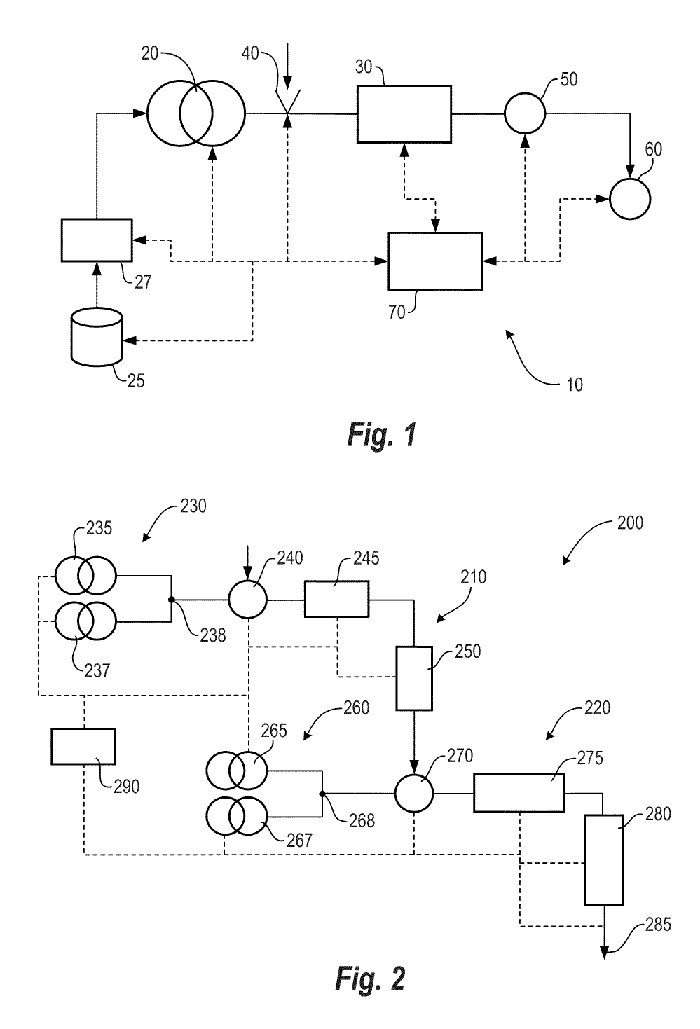

Referring now in greater detail to the drawings, FIG. 1 depicts a general schematic of a liquid separation system 10. A pump 20 receives a mobile phase from a solvent supply 25, typically via a degasser 27, which degases and thus reduces the amount of dissolved gases in the mobile phase. The pump 20—as a mobile phase 25 drive—drives the mobile phase through a separating device 30 (such as a chromatographic column) comprising a stationary phase. A sampling unit 40 can be provided between the pump 20 and the separating device 30 in order to subject or add (often referred to as sample introduction) a sample fluid into the mobile phase. The stationary phase of the separating device 30 is adapted for separating compounds of the sample liquid. A detector 50 is provided for detecting separated compounds of the sample fluid. A fractionating unit 60 can be provided for outputting separated compounds of sample fluid.

While the mobile phase can be comprised of one solvent only, it may also be mixed from plural solvents. Such mixing might be a low pressure mixing and provided upstream of the pump 20, so that the pump 20 already receives and pumps the mixed solvents as the mobile phase. Alternatively, the pump 20 might be comprised of plural individual pumping units, with plural of the pumping units each receiving and pumping a different solvent or mixture, so that the mixing of the mobile phase (as received by the separating device 30) occurs at high pressure and downstream of the pump 20 (or as part thereof). The composition (mixture) of the mobile phase may be kept constant over time, the so called isocratic mode, or varied over time, the so called gradient mode.

A data processing unit 70, which can be a conventional PC or workstation, might be coupled (as indicated by the dotted arrows) to one or more of the devices in the liquid separation system 10 in order to receive information and/or control operation. For example, the data processing unit 70 might control operation of the pump 20 (e.g. setting control parameters) and receive therefrom information regarding the actual working conditions (such as output pressure, flow rate, etc. at an outlet of the pump). The data processing unit 70 might also control operation of the solvent supply 25 (e.g. setting the solvent/s or solvent mixture to be supplied) and/or the degasser 27 (e.g. setting control parameters such as vacuum level) and might receive therefrom information regarding the actual working conditions (such as solvent composition supplied over time, flow rate, vacuum level, etc.). The data processing unit 70 might further control operation of the sampling unit 40 (e.g. controlling sample injection or synchronization sample injection with operating conditions of the pump 20). The separating device 30 might also be controlled by the data processing unit 70 (e.g. selecting a specific flow path or column, setting operation temperature, etc.), and send—in return—information (e.g. operating conditions) to the data processing unit 70. Accordingly, the detector 50 might be controlled by the data processing unit 70 (e.g. with respect to spectral or wavelength settings, setting time constants, start/stop data acquisition), and send information (e.g. about the detected sample compounds) to the data processing unit 70. The data processing unit 70 might also control operation of the fractionating unit 60 (e.g. in conjunction with data received from the detector 50) and provides data back.

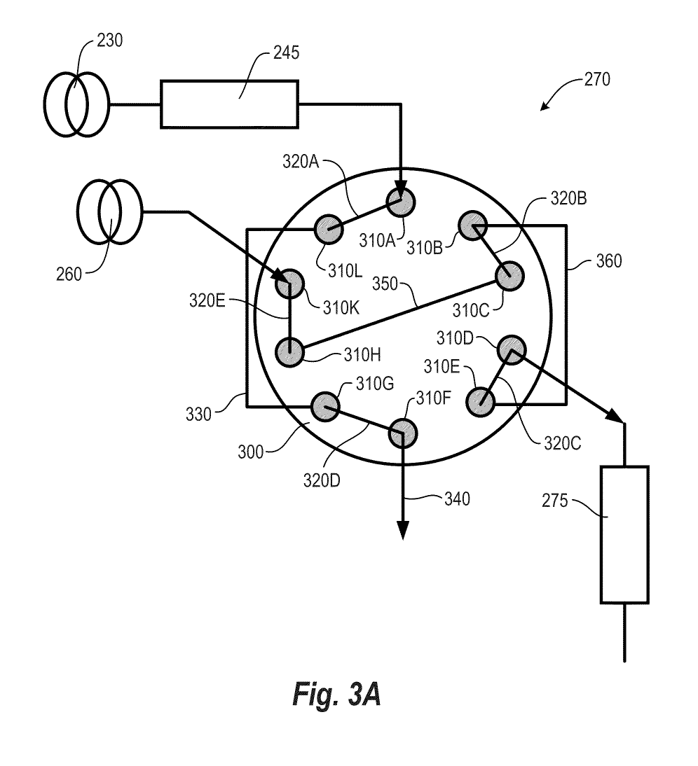

In two-dimensional liquid chromatography, output (eluent) from a first column is input to a second column, preferably having different properties. FIG. 2 schematically illustrates a two-dimensional fluid separation system 200. A first liquid chromatograph 210 is coupled with a second liquid chromatograph 220, so that an output of the first liquid chromatograph 210 can be injected and thus provides an input into the second liquid chromatograph 220. Each of the first and second liquid chromatographs 210 and 220 can be set up in accordance with the one-dimensional liquid chromatograph 10 as schematically depicted in FIG. 1. For the sake of simplicity, only the components relevant for the interaction of the first and second liquid chromatographs 210 and 220 shall be depicted in FIG. 2. Further, while the two-dimensional liquid chromatography system 200 can be set up by two substantially independent chromatographs (as for example depicted in FIG. 1), it goes without saying that the system 200 may also be embodied as a more or less integrated system, or may even be embodied as a fully integrated system, for example in a microfluidic application as described in US 2006/0171855 A1, which teaching with respect to integration of two-dimensional chromatography shall be incorporated herein by reference.

In the embodiment of FIG. 2, the first liquid chromatograph 210 comprises a pump 230, which may be embodied as an isocratic pump with only one pumping unit 235 or as a gradient pump with plural pumping unit. Here, the pump 230 shall have two pumping units 235 and 237 coupled to a mixing point 238, thus allowing to be operated in isocratic as well as gradient mode. The first liquid chromatograph 210 further comprises a sampling unit 240, a separating device 245 (such as a chromatographic column), and may also have a detector 250 for monitoring separation in the first dimension.

The second liquid chromatograph 220 in the example of FIG. 2 is build up substantially in accordance with the first liquid chromatograph 210 and comprises a 30 pump 260 having a first pumping unit 265 and a second pumping unit 267, both coupled together to a mixing note 268. It is clear that the pump 260 may also comprise only the first pumping unit 265, preferentially equipped for low pressure proportioning, but may also have the two pumping units 265 and 267 in order to allow being operated in fast gradient mode or to provide a rapid change in solvent mixture. Further, the second liquid chromatograph 220 comprises a sampling unit 270, a separation unit 5 275, which may be a chromatographic column, and a detector 280. An output of the second liquid chromatograph 220 is depicted schematically by reference numeral 285, and may be a fractionator, an additional detector like a mass spectrometer or an input to a further chromatography dimension, or any other output as well-known in the art.

FIG. 2 further shows a controller 290, which can be coupled to each of the devices in units as depicted in FIG. 2 and as indicated by the dotted lines. The dotted lines shall indicate communication paths, which may be one directional or two-directional communication paths allowing to either only receive or transmit data signals all both. For speed-critical coordination these communication paths can also support direct information transfer among the devices, like from the pumping unit 267 to the sampling unit 270. The explanations given above with respect to the controller 70 shall apply, mutatis mutandis, also to the controller 290.

In operation, the pump 230 of the first liquid chromatograph 210 drives a mobile phase, which might be a solvent mixture provided by the two pumping units 235 and 237, towards the separation unit 245. A sample fluid can be injected into the 20 mobile phase by means of the sampling unit 240. Such sample injection is preferably done as described in U.S. Pat. No. 4,939,943 A, which teaching shall be incorporated herein by reference. The injected sample fluid transported by the mobile phase is driven through the separation unit 245, which separates compounds of the sample fluid as described in the introductory part of the description and as well-known in the art. The (optional) 25 detector 250 may detect occurrence of the separated compounds of the sample fluid.

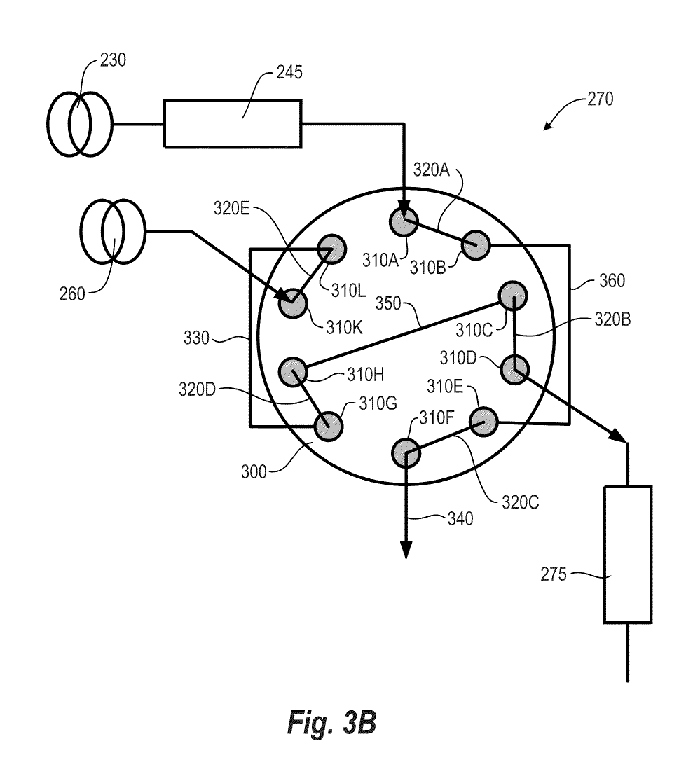

The output from the first liquid chromatograph 210 is provided as input into the second liquid chromatograph 220. This is accomplished by means of the injector 270, which will be explained in greater detail with respect to FIG. 3. The injector 270 is configured to inject the output from the first liquid chromatograph 210 into a mobile 30 phase provided by the pump 260 and driven through the separation unit 275 of the second liquid chromatograph 220. The separation unit 275 further separates compounds of the injected sample compounds from the first liquid chromatograph 210, which may then be detected by the (optional) detector 280 and output by the output 285.

The controller 290 may control one or more operations in the above outlined sequence of operations in the two-dimensional separation provided in the system 200. In the example here, the controller 290 at least controls operation of the injector 270 in conjunction with operation of the pump 260 (including both pumping units 265 and 267), as will be explained in further detail later. The controller 290 may use an output from the detector 250 for controlling the injector 270.

As described in the documents cited in the introductory part of the description, sample introduction from the first chromatography dimension into the second chromatography dimension can be critical for the entire separation process and needs to be well controlled. In particular, timing of the injection as well as volume of the injection can be critical. By nature of this configuration of slicing the result of first dimension separation by the second -dimension separation, it can be very critical to achieve dense slicing of the volume leaving the first -dimension. Especially gradients in the second dimensions may have to be generated fast. As a result, only little delay or mixing should be allowed between pump 260 and before the injector 270, e.g. between the mixing point 268 and the injector 270 in case of two pumps 265 and 267, or between the pump 265 and the injector 270 in case of only one pump 265. In order to still achieve reproducible elution, it can be a critical feature to have the gradient event to start under specific conditions.

The first liquid chromatograph 210 can provide a different separation method as compared to the second liquid chromatograph 220 in order to increase efficiency and resolution of the combined 2D-separation. In the example of FIG. 2, the separation unit 245 of the first liquid chromatograph 210 shall be an ion exchange separation/chromatograph, and the separation unit 275 of the second liquid chromatograph 220 shall be a reversed phase separation/chromatograph.

FIGS. 3A and 3B show an embodiment of the injector 270 depicted in the context of the embodiment of FIG. 2. The injector 270 in this embodiment comprises an 10/2-valve 300, which is a valve having ten ports 310A-310L and two operation positions, while five channels 320A-320E each connect two neighboring ports respectively. FIG. 3A shows a first operation position of the valve 300, and FIG. 3B shows a second operation position of the valve 300. Each port 310A-310H allows coupling a fluidic channel or conduit thereto as exemplary shown in FIGS. 3A and 3B. Each channel 320 can couple two neighboring ports 310 to provide fluid communication therebetween.

In the position of the example shown in FIG. 3A, channel 320A couples ports 310A and 310L, channel 320B couples ports 310B and 310C, etc. The valve 300 in this embodiment shall be a rotary valve allowing to relatively rotate the channels 320 10 with respect to the ports 310. Accordingly, by rotating the channels 320 by one position in clockwise direction, this will provide (shown in FIG. 3B) channel 320A connecting ports 310A and 310B, channel 320B connecting ports 310C and 310D, etc. It is clear that other designs of the ports and channels may be used accordingly and that other types of valves, e.g. translatory valves, or even combinations of valves may be used as well.

In the position of the ports 310 and the channels 320 as depicted in FIG. 3A, the pump 230 drives the mobile phase (with or without the sample fluid injected) through the separation unit 245 of the first liquid chromatograph 210 and towards port 310A of valve 300 of the injector 270. In the position shown in FIG. 3A, the port 310A is coupled via channel 320A to the port 310L, which is coupled to a first sample loop 330 coupling to port 310G. Port 310G is coupled via channel 320D to port 310F, which is coupled to an output 340 which might be a waste output. In this position, the first sample loop 330 is loaded with the output of the first liquid chromatograph 210.

Pump 260 of the second liquid chromatograph 220 is coupled to port 310K, which couples via channel 320E to port 310H. A fluid conduit 350 (e.g. a capillary) is coupled between ports 310H and 310C. Port 310C is coupled via channel 320B to port 310B, which is further coupled via a second sample loop 360 to port 310E, which port 310E is coupled via channel 320C to port 310D and thus to the separation unit 275 of the second liquid chromatograph 220. In this configuration, the pump 260 drives its mobile phase through the second sample loop 360, so that the content of the second sample loop 360, which has been loaded thereto in a previous loading cycle of the injector 270 (as will also be explained later with respect to FIG. 3B), becomes injected into the mobile phase from the pump 260 and transported through the separation unit 275, which may further separate compounds of the compounds injected with the second sample loop 360.

Rotating the channels 320 from the positions shown in FIG. 3A by one port clockwise (which corresponds in function rotating anti-clockwise) will connect the pump 230 and the separation unit 245 via the channel 320A to the second sampling loop 360, which again is coupled via channel 320C to the output 340, which can be waste. This way, the second sample loop 360 is loaded with the output of the first liquid chromatograph 210. The pump 260 is coupled via the channel 320E to the first sample loop 330, which had been loaded in the previous cycle as shown in FIG. 3A. The first sample loop 330 is coupled via channel 320D, the fluid conduit 350, and the channel 320B to the separation unit 275. In this configuration, the pump 260 drives its mobile phase through the first sample loop 330, so that the content of the first sample loop 330, which has been loaded thereto in the previous loading cycle depicted in FIG. 3A, becomes injected into the mobile phase from the pump 260 and transported through the separation unit 275, which may further separate compounds of the compounds injected with the first sample loop 330

Alternative to the example of the injector 270 of FIG. 3, other embodiments for the injector 270 may be used accordingly, for example with only one sample loop, more than two sample loops, one or more enrichment columns, and/or other features as known in the art, e.g. as described in “Highly efficient peptide separations in proteomics—Part 2: Bi- and multidimensional liquid-based separation techniques”, by Koen Sandra, Mahan Moshir, Filip D'hondt, Robin Tuytten, Katleen Verleysen, Koen Kas, Isabelle Franc, Pat Sandra, Journal of Chromatography B, 877 (2009) 1019-1039.

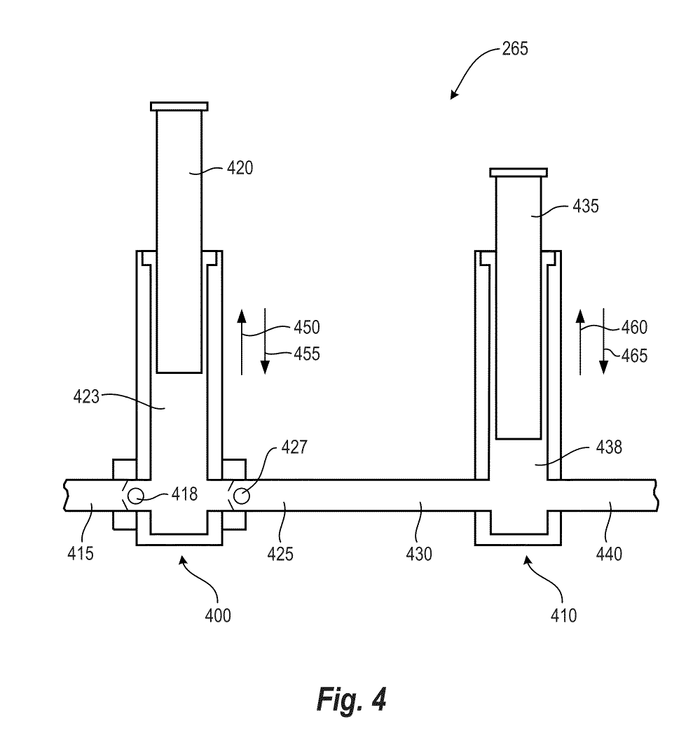

FIG. 4 shows an embodiment of the pumping unit 265 (cf. FIG. 2) as a dual piston serial-type pump. While only the pumping unit 265 shall be shown here in greater detail, each of the pumping unit 235, 237, and 267 may also be embodied as shown in FIG. 4, so that the explanations as given in FIG. 4 with respect to the pumping unit 265 shall apply accordingly.

The pumping unit 265 comprises a primary piston pump 400 that is fluidically connected in series with a secondary piston pump 410. The primary piston pump 400 comprises an inlet 415 having an inlet valve 418, a piston 420 that reciprocates in a pumping chamber 423 of the primary piston pump 400, and an outlet 425 having an outlet valve 427. The outlet 425 is fluidically connected with an inlet 430 of the secondary piston pump 410. A piston 435 reciprocates in a secondary pumping chamber 438 of the secondary piston pump 410. The secondary piston pump 410 further comprises an outlet 440 for delivering a flow of fluid.

Operation of the dual piston pump as shown in FIG. 4 is disclosed in detail in US 2010/0275678 A1_ by the same applicant, which teaching shall be incorporated herein by reference. During an intake phase of the primary piston pump 400, the primary piston 420 performs an upward stroke, as indicated by arrow 450. The inlet valve 418 is opened, and fluid (typically at atmospheric pressure) is drawn into the primary piston chamber 423. When the primary piston 420 performs a compression stroke in a downward direction indicated by arrow 455, the fluid contained in the chamber 423 is compressed to a system pressure (e.g. of several hundred or even more than thousand bar). During the compression phase, both the inlet valve 418 and the outlet valve 427 are closed. When the fluid contained in the chamber 423 has reached system pressure, the outlet valve 427 opens. In a subsequent delivery phase of the primary piston pump 400, the primary piston 420 continues its downward movement 455, and a flow of fluid is dispensed at the outlet 427 of the primary piston pump 400. During a deliver-and-fill phase, the flow of fluid provided by the primary piston pump 400 is supplied to the secondary piston pump 410 as well as into the fluid system located downstream of the pumping unit 265 beyond the outlet 440, and the pumping chamber 438 of the secondary piston pump 410 is filled. During the deliver-and-fill phase, the secondary piston 435 is moved in upwards direction indicated by arrow 460. Subsequently, the piston 435 of the secondary piston pump 410 will reverse movement to a downwards movement, indicated by arrow 465, and further dispends fluid at system pressure into the system at outlet 440, while at the same time the primary piston 420 of the primary piston pump 400 stops. To finish a full pump cycle it then moves upwards in direction 450 in order to refill the pumping chamber 423 with fluid provided from the inlet 415.

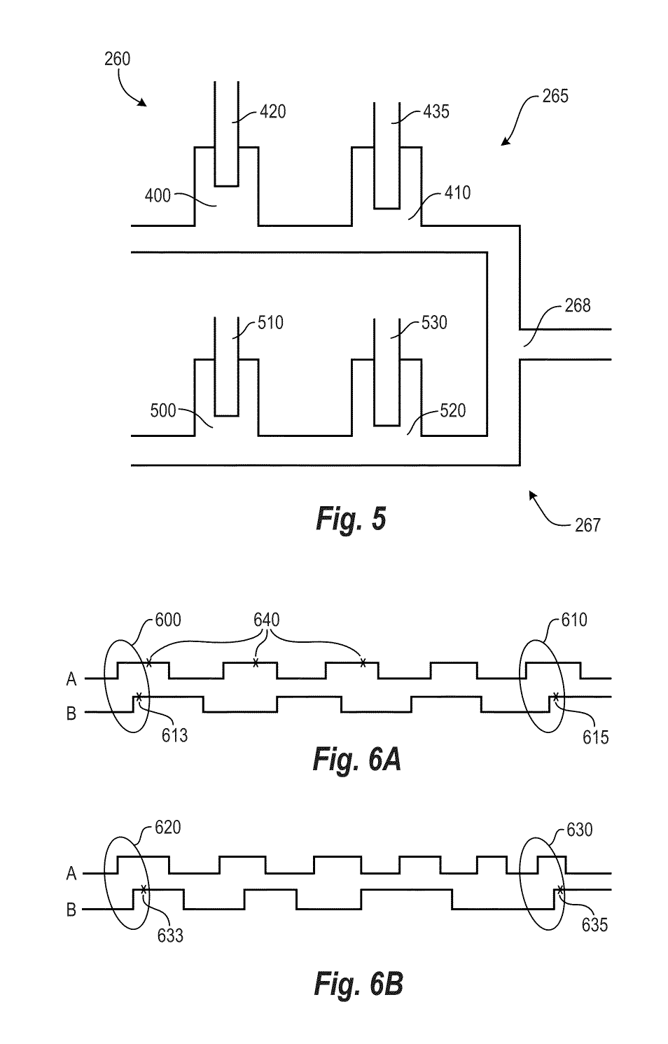

FIG. 5 schematically illustrates an embodiment of the pump 260, wherein both pumping units 265 and 267 are each comprised by a dual serial type pumping unit as schematically depicted in FIG. 4. The pump 230 of the first liquid chromatograph 210 may be embodied accordingly.

The second pumping unit 267 shall be embodied in accordance with the first pumping unit 265 and comprise a primary piston pump 500, having a reciprocating piston 510, coupled in series with a secondary piston pump 520 having a reciprocating piston 530.

While the respective secondary piston 435, 530 in each pumping unit 265 and 267 is provided in order to achieve a substantially continuous output flow at each channel towards the mixing point 268, the hydraulic work to bring the input flow to high pressures is mainly achieved by the movement of the respective primary pistons 420 and 510. Accordingly, the secondary pistons 435 and 520 can be regarded as dominating the respective output flow characteristic. As already explained above, two or more or the pumping units 265 and 267 are required only when a mixture is to be provided from different solvents each pumped by a respective one of the pumping units 265 and 267. Accordingly, in case only one solvent is to be provided, the pumping unit 265 alone might be sufficient with no further pumping unit coupled thereto. In case of a mixture of more than two different solvents, more than the two pumping units 265 and 267 may be coupled to the mixing point 268. Alternatively or in addition, adequate valves coupling to different solvent supplies may be coupled to the input of the respective primary piston pumps 400, 500 (e.g. to input 415 of primary pump 400, cf. FIG. 4).

FIGS. 6A and 6B schematically illustrate examples of piston movements for an isocratic mode (FIG. 6A) and a gradient mode (FIG. 6B). In the isocratic mode of FIG. 6A, both pumping units 265 and 267 are each pumping different solvents at a given ratio towards the mixing point 268. The upper line, denoted as A, shall represent movement of the secondary piston 435—in a Boolean representation—of the direction of movement. A downwards movement (see arrow 465 in FIG. 4) is represented by an upper position of line A, and a lower position of graph A shall represent upwards movement (see arrow 460 in FIG. 4) of the secondary piston 435. Accordingly, graph B in the lower portion of FIG. 6A schematically shows the movement of the secondary piston 530, with the upper position also representing a downwards movement, and the lower position representing an upwards movement (corresponding to the movements illustrated in FIG. 4 with respect to the secondary piston pump 410).

As can be seen from FIG. 6A, with both secondary pistons 435 and 530 reciprocating at different frequencies, the graphs A and B only show matching phase relationship at a state 600 and a state 610. At such states 600 and 610, the secondary pistons 435 and 530, and thus the pump units 265 and 267, are in a given relationship with respect to each other. In each of the states 600 and 610, the two pumping units 265 and 267 can be regarded as being in a specific mechanical configuration with respect to each other. As also detailed in the aforementioned DE 102008000111 A1, the specific mechanical configuration of the pumping system can have an influence on the precision, in particular the repeatability, of a separation. Accordingly, when injecting a sample fluid when the pumping system has a given mechanical configuration, repeatability of the separation and accuracy of the entire analysis can be improved.

The controller 290 will support controlling an injection event (when an output of the first liquid chromatograph 210 is injected into the second liquid chromatograph 220) in relation to a given state of either the piston 435 only (in case the pump 260 comprises only the pumping unit 265) or to the states of each secondary piston of the respective pumping units (e.g. 265 and 267). This can be achieved, e.g., by polling states from the pumping unit 265 and providing such information to injector 270, or it can command the pumping unit 265 to trigger the action of injector 270 directly.

In the example of FIG. 6A, the controller 290 will control an injection event in relation to the occurrence of the repeating states 600 and 610 at which the mechanical orientation of the secondary pistons 435 and 530 is the same or at least substantially the same. As an example, the controller 290 can control the injection event to occur at a defined mechanical configuration in or during the repeating states 600 and 610, for example, by initiating the injector 270 to switch to a successive state (as explained with respect to FIGS. 3A and 3B) at a defined timing after the graph B has transitioned to the upper position, as denoted by “x” and with reference numerals 613 and 615 in FIG. 6A. At timings 613 and 615, the secondary pistons of both pumps 265 and 267 are in downwards movement, thus supplying fluid towards the mixing point 268, while the respective primary pistons of both pumps 265 and 267 are not de-filling towards the secondary pistons. It is clear that the injection events at reference numerals 613 and 615 are only schematically depicted, and that other timings for the injection can be selected e.g. during the repeating state 600, which however is then repeated in further repeating states (e.g. repeating state 610) of a series of related injections.

FIG. 6B illustrates an example of the movement and mechanical configurations of the secondary pistons 435 and 530 when being in a gradient mode, 10 wherein the mixing ratio of the solvents supplied by the pumping unit 265 and 267 varies over time. In the example of FIG. 6B, the duration of the pumping phase of the secondary piston 435, as indicated by graph A, shall decrease over time (pumping faster), while the duration of the pumping phase of the secondary piston 530, indicated by graph B, shall increase over time (flow ramps down). The explanations of FIG. 6A with respect to the graphs A and B shall apply to FIG. 6B accordingly.

As can be seen in FIG. 6B, a state 620 of a certain relationship between the positions and movements of the secondary pistons 435 and 530 will repeat at a state 630. Accordingly, the controller 290 will control an injection event, for example, in relation to the repeating state 620 and 630. As an example, the controller 290 can 20 control the injection event to occur at a defined mechanical configuration in or during the repeating states 620 and 630, for example, by initiating the injector 270 to switch to a successive state (as explained with respect to FIGS. 3A and 3B) at a defined timing after the graph B has transitioned to the upper position, as denoted by “x” and with reference numerals 633 and 635 in FIG. 6B. It is clear that the injection events at reference numerals 633 and 635 are only schematically depicted, and that other timings for the injection can be selected e.g. during the repeating state 620, which however is then repeated in further repeating states (e.g. repeating state 630) of a series of related injections.

In case the pump 260 only comprises one pumping unit 265, the injection event is controlled to a specific state of the first piston 420 only, for example, when the secondary piston 435 is at a given mechanical position denoted by “x” and reference numeral 640 in FIG. 6A. In the example of FIG. 6A, reference numeral 640 represents a selected position of the secondary piston 435 with respect to a top dead center or an outer dead center of the piston 435 and also at a given direction of movement, here the downwards movement 465 (cf. FIG. 4).

It is clear that instead of the states 600, 610, 620, 630 and 640, as indicated in FIG. 6A and 6B, any other suitable state representing a given and repeatable mechanical configuration can be used for relating the injection event thereto. However, dependent on the specific mechanical configuration, certain states may also be excluded, for example, when the secondary piston 435 is at a reversal point or in a certain range before or after such reversal point. As such reversal point may represent a critical mechanical configuration, the controller 290 may also relate the injection events not to coincide with such reversal points or ranges around the reversal points, as also outlined in the aforementioned DE 102008000111 A1, which teaching in that respect shall be incorporated herein by reference. Further or in addition, a cycle wherein the primary pump 400 supplies into the secondary pump 410, the so-called de-fill cycle, may be excluded in order to avoid variations in channel capacitance.

The injection event may be a mechanical movement of parts or just a flip in a flow stream.

In the implementation as given in FIG. 3, the rotor of the valve 300 has two functional positions (depicted in FIGS. 3A and 3b) and will be switched from one to the 20 other, preferably by rapid movement. In case of a microfluidic flow stream splitter (like a Dean's Switch, see e.g. “Microfluidic Deans Switch for Comprehensive Two-Dimensional Gas Chromatography”, by John V. Seeley, Nicole J. Micyus, Steven V. Bandurski, Stacy K. Seeley, and James D. McCurry, in Anal. Chem., 2007, 79 (5), pp 1840-1847; U.S. Pat. No. 5,492,555 A; or in “Two Dimensional GC Using Agilent's Deans Switch 2310-0129”, 5988-9530EN, 2003, http://www.chem.agilent.com/Library/technicaloverviews/Public/5988-9530EN.pdf), the flow stream may be diverted by guiding the flow a different route.

An injection event may be the triggering for a motion of a drive of the injector 270 to move from one position to a next, which results in altering a flow 30 direction (the concept is shown in FIGS. 3A and 3B). Such drive may be a motor, a solenoid, a set of solenoids, a pneumatic drive, and/or a hydraulic drive to actuate the injector 270. There may also be a construction with a set of valves performing such an injection event. In this case an injection event may be a combination of valve switching or a sequential activation of valves

1. A method of providing two-dimensional liquid chromatography in a system comprising a first liquid chromatograph coupled with a second liquid chromatograph, the method comprising:
controlling an injection event of injecting an output of the first liquid chromatograph into the second liquid chromatograph in relation to a state of the second liquid chromatograph.

2. The method of claim 1, wherein the second liquid chromatograph comprises a reciprocating pump, the reciprocating pump is a dual pump having a primary piston and a secondary piston, the primary piston is configured to intake fluid and to supply the fluid to the secondary piston, the secondary piston is configured to output the fluid under pressure, 15 and the state is defined by at least one of: □ at least one of a moving direction and a position of the secondary piston, □ a cycle wherein the primary piston does not supply fluid to the secondary piston.

3. The method of claim 1, wherein the second liquid chromatograph is operated in a gradient mode, wherein a composition of a solvent mixture is varied over time, and the solvent mixture provides a mobile phase for transporting the injected output of the first liquid chromatograph.

4. The method of claim 1, wherein the second liquid chromatograph comprises a first reciprocating pump having a first piston reciprocating in the first reciprocating pump, and a second reciprocating pump having a second piston reciprocating in the second reciprocating pump, the method comprising:
controlling the injection event in relation to the state of the first piston as well as to a state of the second piston.

5. The method of claim 4, wherein the first reciprocating pump is operated to pump a first solvent, and the second reciprocating pump to is operated to pump a second solvent, the first and second solvents being mixed to a solvent mixture and provided to a separation unit of the second liquid chromatograph, and the output of the first liquid chromatograph is injected into the solvent mixture.

6. The method of claim 1, comprising at least one of:
the state is defined by at least one of a moving direction and a position of a piston reciprocating in a reciprocating pump of the second liquid chromatograph;
the state of the piston is a given state as defined by at least one of a user of the system and a control unit in the system;
the state of the piston is defined by a distance from at least one of a top dead center and an outer dead center of the piston in the reciprocating pump;
the state of the piston is being or not being in a reversal point of the piston,
the state of the piston is being at the same state of the piston, when a previous injection occurred;
the state of the piston is being at at least one of the same position and the same moving direction of the piston, when a previous injection occurred;
the state of the piston is being at at least one of the same position and the same moving direction of the piston, when a first injection in a sequence of injections.

7. The method of claim 1, further comprising at least one of:
controlling operation of the second liquid chromatograph in order to set the state in relation to a desired value for the injection event;
controlling operation of a reciprocating pump of the second liquid chromatograph in order to set the state of the second liquid chromatograph in relation to a desired value for the injection event.

8. The method of claim 1, further comprising at least one of:
controlling operation of the second liquid chromatograph in order to set the state in relation to a desired value of an injection volume as a volume of the output of the first liquid chromatograph injected into the second liquid chromatograph;
controlling operation of the first reciprocating pump of the second liquid chromatograph in order to set the state of a piston in relation to a desired value of an injection volume as a volume of the output of the first liquid chromatograph injected into the second liquid chromatograph.

9. The method of claim 1, comprising
controlling a plurality of injection events, each representing an injection of a respective output of the first liquid chromatograph as respective input into the second liquid chromatograph, in relation to a pattern of the state.

10. The method of claim 9, comprising at least one of:
the pattern is a repetitive pattern;
the pattern is a pattern of the state of the first piston reciprocating in the first reciprocating pump;
the pattern comprises an incident repeating in the pattern, and each injection event is controlled to occur in relation to a respective one of the repeating incidents.

11. The method of claim 8, further comprising at least one of:
controlling operation of the second liquid chromatograph in order to set a repetition rate of the pattern to a desired value;
controlling operation of a pump of the second liquid chromatograph in order to set a repetition rate of the pattern to a desired value;
controlling operation of the second liquid chromatograph in order to vary a repetition rate of the pattern to match with a desired value of a respective injection event;
controlling operation of the first reciprocating pump of the second liquid chromatograph in order to vary a repetition rate of the pattern to match with a desired value of a respective injection event.

12. The method of claim 8, further comprising:
controlling operation of the first liquid chromatograph in order to relate a volume provided as input into the second liquid chromatograph to a repetition rate of the pattern.

13. The method of claim 1, wherein the volume provided as input into the second liquid chromatograph is controlled to be less or equal than a volume allowed by a sample loop for injecting into the second liquid chromatograph.

14. The method of claim 1, comprising:
recording an actually injected volume for a respective injection event, and evaluating a measuring result, measured by the second liquid chromatograph, in relation to the recorded actually injected volume for the respective injection event.

15. The method of claim 1, comprising at least one of: 5 controlling the injection event comprises triggering an injection, at which the output of the first liquid chromatograph is injected as input into the second liquid chromatograph;
controlling the injection event comprises controlling operation of an injection valve.

16. The method of claim 1, comprising separating compounds of a sample fluid by the first liquid chromatograph, injecting a compound, separated by the first liquid chromatograph, into the second liquid chromatograph, and separating compounds of the injected compound by the second liquid chromatograph.

17. The method of claim 1, wherein the first liquid chromatograph provides a different separation mechanism than the second liquid chromatograph.

18. A software program or product, preferably stored on a data carrier, for controlling or executing the method of claim 1 or any of the above claims, when run on a data processing system such as a computer.

19. A two-dimensional fluid separation system comprising: a first liquid chromatograph and a second liquid chromatograph, each configured for separating compounds of a sample fluid, and a controller configured for controlling an injection event of injecting an output of the first liquid chromatograph into the second liquid chromatograph in relation to a state of the second liquid chromatograph.
